(19) United States
(12) Patent Application Publication
(10) Pub. No.: US 2015/0064366 A1
(43) Pub. Date: Mar. 5, 2015

(54) ORIENTATION FILM MATERIALS AND LIQUID CRYSTAL DISPLAY DEVICE USING IT

(71) Applicant: Japan Display Inc., Tokyo (JP)

(72) Inventors: Masaki MATSUMORI, Tokyo (JP); Yasushi TOMIOKA, Tokyo (JP); Noboru KUNIMATSU, Tokyo (JP)

(73) Assignee: Japan Display Inc.

(21) Appl. No.: 14/476,982

(22) Filed: Sep. 4, 2014

(30) Foreign Application Priority Data
Sep. 5, 2013 (JP) 2013-183836

(51) Int. Cl. G02F 1/33

(52) U.S. Cl. CPC G02F 1/33
USPC 428/1.26

(57) ABSTRACT

The long residual image characteristic of a conventional photo-orientation film material is insufficient. A liquid crystal display device comprises substrates, a liquid crystal layer, an electrode group to apply an electric field to the liquid crystal layer, and orientation control films placed between the substrates and the liquid crystal layer. Each of the orientation control films comprises a polyimide and a polyimide precursor, as materials of the polyimide and the polyimide precursor, at least one kind of first diamines, at least one kind of second diamines, and a cyclobutane tetracarboxylic dianhydride derivative are contained, and an orientation restraining force is granted by the irradiation of nearly linearly polarized light.

### CLAIM OF PRIORITY

The present application claims priority from Japanese patent application JP2013-183836 filed on Sep. 5, 2013, the content of which is hereby incorporated by reference into this application.

### BACKGROUND

The present disclosure relates to an orientation film material and is applicable to a liquid crystal display device having a photo-orientation film for example.

Display in a liquid crystal display device is carried out by applying an electric field to liquid crystal molecules in a liquid crystal layer interposed between a pair of substrates, thereby changing the orientation directions of the liquid crystal molecules, and thus changing the optical characteristic of the liquid crystal layer. In a liquid crystal display device, an orientation control film having a liquid crystal orientation control capability is formed at each of the interfaces between a liquid crystal layer and a pair of substrates holding the liquid crystal layer in between. The orientation control film comprises an organic film such as a polyimide film or the like and is also described as an orientation film. In a conventional mass-production technology, rubbing treatment is applied on the orientation control film and a liquid crystal orientation capability (initial orientation) is granted.

The rubbing orientation treatment however includes a process of physically rubbing an organic film and a cloth together and hence unnecessary shavings may sometimes be generated on the surface of a formed orientation film. The shavings cause a display defect of a display device to be generated and hence a clean orientation treatment method substituted for a rubbing orientation treatment, for example a photo-orientation treatment method, is proposed (for example, Japanese Published Unexamined Application No. 2009-75569 (Patent Literature 1) or U.S. Pat. No. 8,592,009 (Patent Literature 4) corresponding to it).

A photo-orientation treatment is a method of granting an orientation restraining force to the surface of an organic film formed on a substrate surface by irradiating the surface of the organic film with nearly linearly polarized light and it is proposed to use a material having a high sensitivity to light exposure as a liquid crystal orientation material also in order to effectively use the energy of the irradiated light (for example, Japanese Published Unexamined Application No. 2011-186246 (Patent Literature 2) or U.S. Pat. No. 8,580,357 (Patent Literature 5) corresponding to it).

Meanwhile, when a liquid crystal display device is driven, a displayed image burns (a residual image is caused) by a DC charge accumulated at an orientation film interface. An orientation film less causing a displayed image to burn is proposed (for example, Japanese Published Unexamined Application No. 2012-98715 (Patent Literature 3) or Publication of U.S. Patent Application No. 2012/88040 (Patent Literature 6) corresponding to it).

### SUMMARY

The long residual image characteristic of each of the orientation film materials proposed in Patent Literatures 1 to 6 is insufficient.

Other problems and novel features will be obvious from the descriptions in the present disclosure and the attached drawings.

The representative outline of the present disclosure is briefly explained as follows.

That is, an orientation film material comprises a polyimide precursor having an appropriate amount of flexible parts in a rigid main chain skeleton. A liquid crystal display device has an orientation film using the orientation film material.

Such a liquid crystal display device makes it possible to improve a residual image characteristic.

### BRIEF DESCRIPTION OF THE DRAWINGS

FIG. 1 is a schematic sectional view of a liquid crystal display device according to Example 1 in the vicinity of one pixel.

FIGS. 2A to 2C are schematic views of an active matrix substrate explaining a configuration of a liquid crystal display device according to Example 1 in the vicinity of one pixel.

### DESCRIPTION OF THE PREFERRED EMBODIMENTS

The outline of an embodiment is briefly explained as follows.

(1) An orientation film material according to the present embodiment comprises a polyimide and a polyimide precursor, those having an appropriate amount of flexible parts in a rigid main chain skeleton.
(2) In the orientation film material of the above item (1), as the materials of the polyimide and the polyimide precursor, at least one kind of diamines selected from the chemical compound group shown by the following chemical formula (1) (first diamines), at least one kind of diamines selected from the chemical compound group shown by the following chemical formula (2) (second diamines), and a cyclobutane tetracarboxylic dianhydride as an acid anhydride are contained. As a result, the polyimide and the polyimide precursor have an appropriate amount of flexible parts in a rigid main chain skeleton.

H₂N-A¹-NH₂ (1)

Here, A¹ represents a divalent circular substituent.

H₂N-A²ZₙA²-NH₂ (2)

Here, A² individually represents a divalent circular substituent or a single bond, Z individually represents a bond group selected from the group of —(CH₂)—, —(NH)—, —O—, —S—, —SiO₂—, and —CO—, and n represents an integer of 1 or more.

(3) In the orientation film material of the above item (2), desirably, the relational expression 0<n×y<200 is satisfied when at least one kind of the second diamines is contained by y mol % and n is an integer of 2 or more. More desirably, the relational expression 10<n×y≦175 is satisfied. Still more desirably, the relational expression 20≦n×y≦150 is satisfied.
(4) In the orientation film material of the above item (2), desirably, the relational expression 0<(n₁×y₁)+(n₂×y₂)<200 is satisfied when two kinds of the second diamines are contained, n of a diamine is defined as n₁ and the diamine is contained by y₁ mol %, n of the other diamine is defined as n₂ and the other diamine is contained by y₂ mol %, and each of n₁ and n₂ is integer of 2 or more. More desirably, the relational expression 10≦(n₁×y₁)+(n₂×y₂)≦175 is satisfied. Still more desirably, the relational expression 20≦(n₁×y₁)+(n₂×y₂)≦150 is satisfied.
(5) In the orientation film material of the above item (2), desirably the cyclobutane tetracarboxylic dianhydride derivative has a structure represented by the following chemical formula (3).

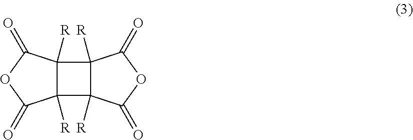

Here, R individually represents an alkyl group having a carbon number of 1 to 8.

(6) In the orientation film material of the above item (2), desirably the polyimide precursor is a polyamide acid alkyl ester having a carbon number of 1 to 8. More desirably, the polyimide precursor contains a polyamide acid.
(7) In the orientation film material of the above item (2), desirably A¹ and A² contain one kind selected from the divalent circular chemical compound group shown by the following chemical formulae (4) to (11).

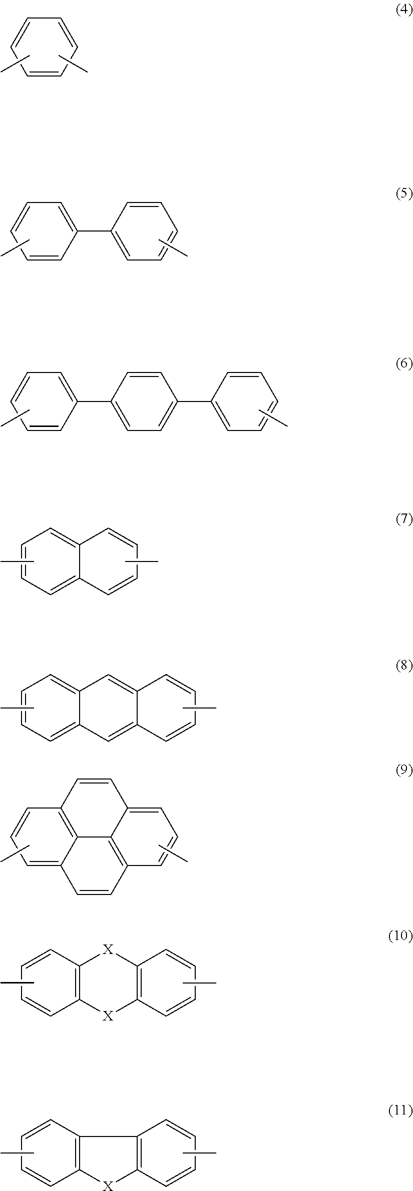

Here, X individually represents a bond group selected from the group of —(CH₂)—, —(NH)—, —O—, —S—, and —CO—.

(8) In the orientation film material of the above item (2), desirably, the relational expression 40<y<100 is satisfied when at least one kind of diamines selected from the chemical compound group shown by the above chemical formula (2) is contained by y and n is 1. More desirably, the relational expression 50≦y≦90 is satisfied. Still more desirably, the relational expression 60≦y≦80 is satisfied.
(9) A liquid crystal display device comprises substrates, a liquid crystal layer, an electrode group to apply an electric field to the liquid crystal layer, and orientation control films placed between the substrates and the liquid crystal layer. Each of the orientation control films comprises a polyimide and a polyimide precursor. As materials of the polyimide and the polyimide precursor, at least one kind of diamines selected from the chemical compound group shown by the above chemical formula (1), at least one kind of diamines selected from the chemical compound group shown by the above chemical formula (2), and a cyclobutane tetracarboxylic dianhydride derivative are contained and an orientation restraining force is granted by the irradiation of nearly linearly polarized light.
(10) In the liquid crystal display device of the above item (9), desirably, the relational expression 0<n×y<200 is satisfied when at least one kind of diamines selected from the chemical compound group shown by the above chemical formula (2) is contained by y and n is an integer of 2 or more. More desirably, the relational expression 10≦n×y≦175 is satisfied. Still more desirably, the relational expression 20≦n×y≦150 is satisfied.
(11) In the liquid crystal display device of the above item (9), desirably, the relational expression 0<(n₁×y₁)+(n₁×y₂)<200 is satisfied when two kinds of diamines selected from the chemical compound group shown by the above chemical formula (2) are contained, n of a diamine is defined as n₁ and the diamine is contained by y₁ (mol %), n of the other diamine is defined as n₂ and the other diamine is contained by y₂ (mol %), and each of n₁ and n₂ is integer of 2 or more. More desirably, the relational expression 10≦(n₁×y₁)+(n₂×y₂)≦175 is satisfied. Still more desirably, the relational expression 20≦(n₁×y₁)+(n₂×y₂)≦150 is satisfied.
(12) In the liquid crystal display device of the above item (9), desirably the cyclobutane tetracarboxylic dianhydride derivative has a structure represented by the above chemical formula (3).
(13) In the liquid crystal display device of the above item (9), desirably the polyimide precursor is a polyamide acid alkyl ester having a carbon number of 1 to 8. More desirably, the polyimide precursor contains a polyamide acid.
(14) In the liquid crystal display device of the above item (9), desirably A¹ and A² contain one kind selected from the divalent circular chemical compound group shown by the above chemical formulae (4) to (11).
(15) In the liquid crystal display device of the above item (9), desirably, the relational expression 40<y<100 is satisfied when at least one kind of diamines selected from the chemical compound group shown by the above chemical formula (2) is contained by y (mol %) and n is 1. More desirably, the relational expression 50≦y≦90 is satisfied. Still more desirably, the relational expression 60≦y≦80 is satisfied.

### <First Diamines>

First diamines are substances shown by the following chemical formulae (A-1) to (A-13) for example. The first diamines however are not limited to those substances.

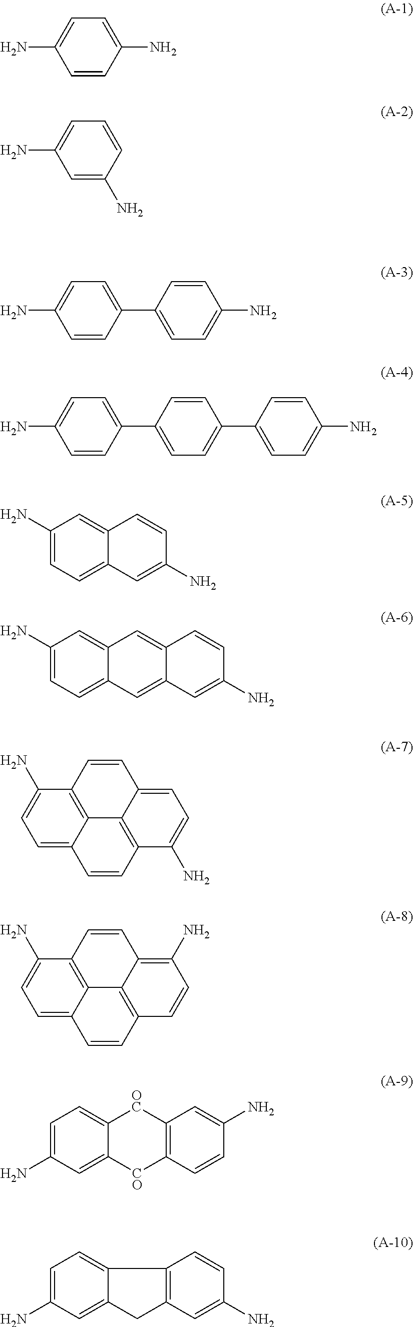

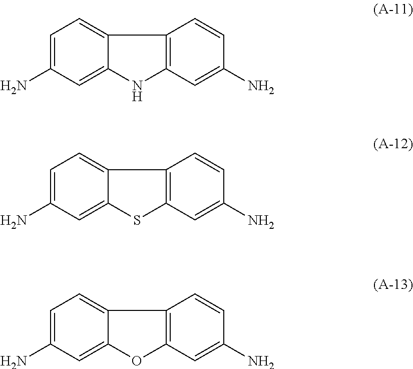 [SMILES: Nc1ccc2c(c1)[nH]c1cc(N)ccc12 ; Nc1ccc2c(c1)sc1cc(N)ccc12 ; Nc1ccc2c(c1)oc1cc(N)ccc12]

### <Second Diamines>

Second diamines are substances shown by the following chemical formulae (B-1) to (B-10) for example. The second diamines however are not limited to those substances. Here, n is 2 in the chemical formulae (B−1) to (B-3) and (B-7), n is 3 in the chemical formula (B-5), n is 5 in the chemical formulae (B-4) and (B-10), n is 6 in the chemical formula (B-6), n is 7 in the chemical formula (B-8), and n is 9 in the chemical formula (B-9)

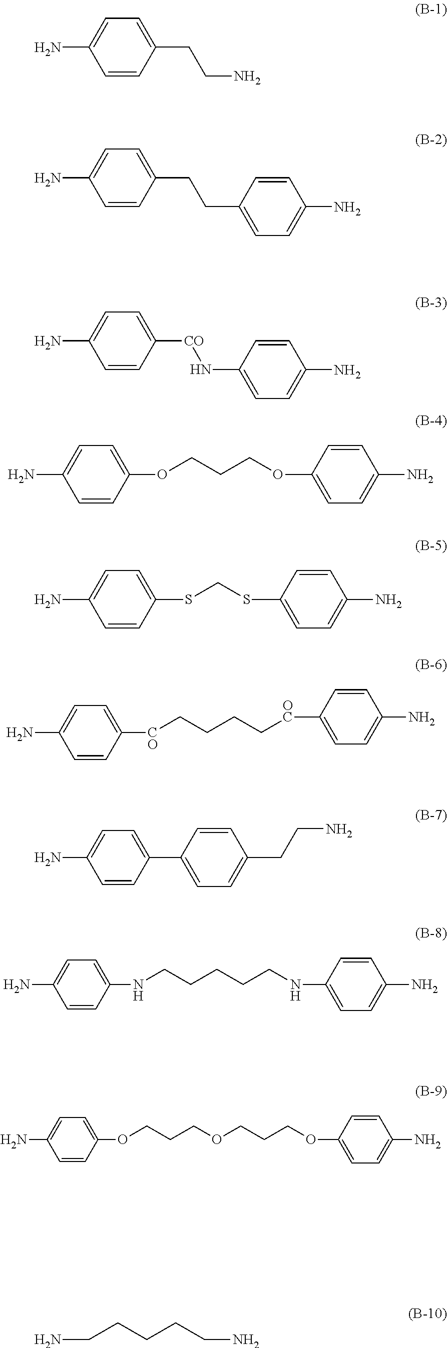

Second diamines of n=1 are substances shown by the following chemical formulae (B′-1) to (B′-6) for example. The second diamines of n=1 however are not limited to those substances.

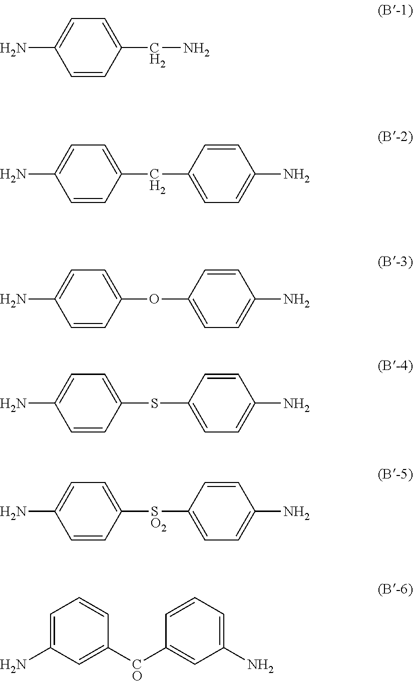

### <Cyclobutane Tetracarboxylic Dianhydride Derivatives>

Cyclobutane tetracarboxylic dianhydride derivatives are substances shown by the following chemical formulae (C-1) to (C-8) for example. They however are not limited to those substances.

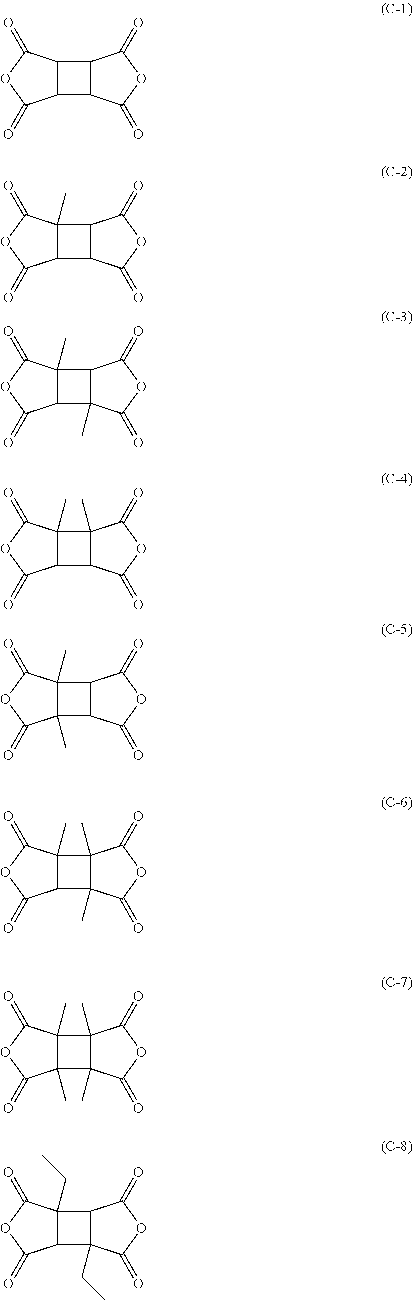

### <Synthesis Methods of Polyamide Acid and Polyamide Acid Alkyl Ester>

A polyamide acid can be obtained by agitating and polymerizing a diamine and a tetracarboxylic dianhydride in an organic solvent.

Concretely, a diamine is dissolved in a polar amide solvent such as NMP (N-methylpyrrolidone). When a tetracarboxylic dianhydride of moles nearly equivalent to the diamine is added into the solvent and agitated at room temperature, a ring-opening addition polymerization reaction progresses between the tetracarboxylic dianhydride and the diamine together with the dissolution of the tetracarboxylic dianhydride and a polyamide acid of a high molecular weight is obtained.

Meanwhile, in the case of a polyamide acid ester, a high-reactive diester dicarboxylic acid chloride is obtained by reacting a diester dicarboxylic acid obtained by reacting a tetracarboxylic dianhydride with alcohol with a chlorination reagent such as thionyl chloride. A polyamide acid alkyl ester is obtained by reacting and polycondensating it with a diamine.

On this occasion, it is possible to obtain a copolymerized polymer wherein a plurality of chemical species are polymerized with a polymer chain by mixing several kinds of materials comprising diamines and tetracarboxylic dianhydrides.

Reference literature: “Latest Polyimide—Foundation and Application—” (2002), NTS Inc.

Examples are explained hereunder in reference to drawings. Here, in the following explanations, an identical constituent component is represented by an identical symbol and the repetition of explanation is avoided. In the following examples, the explanations are based on the structure of an IPS-type liquid crystal display device of a system to drive a liquid crystal by a horizontal electric field. An orientation film material according to the present embodiment is preferably applicable to an IPS-type liquid crystal display device of a system to drive a liquid crystal by a horizontal electric field, but is not limited to the application, and is also applicable to a liquid crystal display device of another display mode.

### Example 1

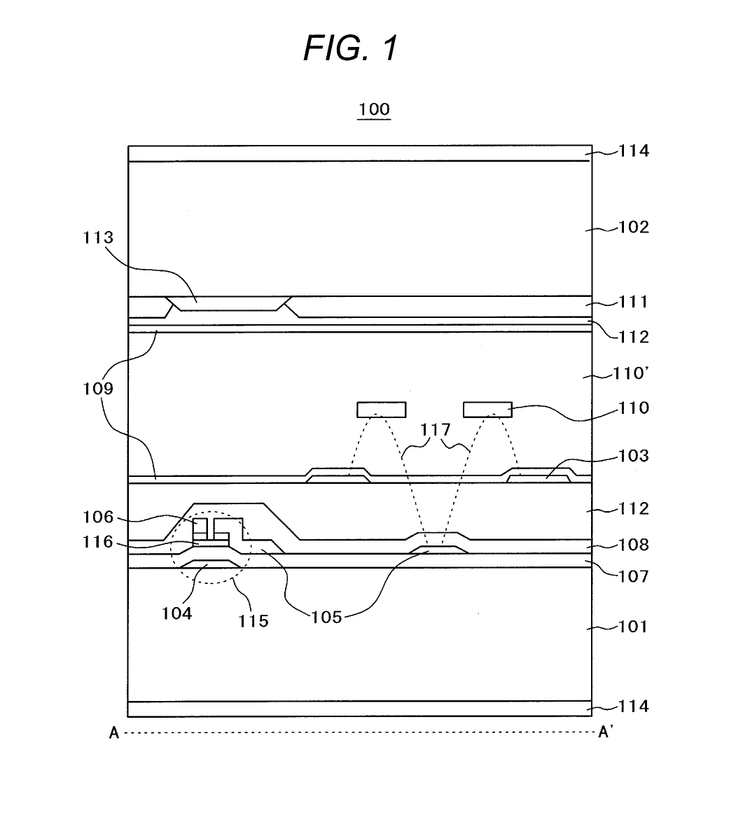

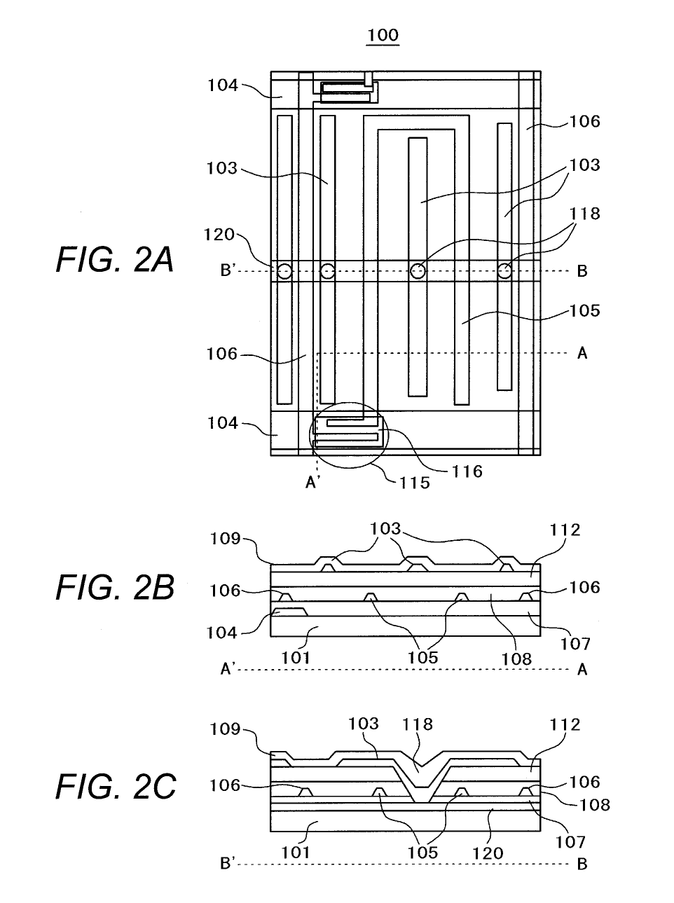

FIG. 1 is a schematic sectional view of a liquid crystal display device according to Example 1 in the vicinity of one pixel. Further, FIGS. 2A to 2C are schematic views of an active matrix substrate explaining a configuration of a liquid crystal display device according to Example 1 in the vicinity of one pixel; FIG. 2A shows a plan view, FIG. 2B shows a sectional view taken on line A-A′ in FIG. 2A, and FIG. 2C shows a sectional view taken on line B-B′ in FIG. 2A. Furthermore, FIG. 1 corresponds to a part of the section taken on line A-A′ in FIG. 2A. Here, FIGS. 2B and 2C are schematically shown in a manner of emphasizing the configuration of a substantial part and do not correspond to the sections taken on lines A-A′ and B-B′ in FIG. 2A on a one-to-one basis.

In a liquid crystal display device 100, a scanning wire (gate electrode) 104 and a common electrode wire (common wire) 120, those comprising metal films, are placed over a glass substrate 101 constituting an active matrix substrate and an insulation film 107 is formed in the manner of covering the gate electrode 104 and the common wire 120. Further, a semiconductor film 116 is placed over the gate electrode 104 through the insulation film 107 and is designed so as to function as an active layer of a thin film transistor (TFT) 115 as an active element. Furthermore, a signal wire (drain electrode) 106 and a pixel electrode (source electrode) 105, those comprising metal films, are placed in the manner of overlapping with a part of the pattern of the semiconductor film 116 and an insulation film 108 is formed in the manner of covering the all components.

Further, as shown in FIG. 2C, a common electrode 103 connected to the common wire 120 through a through hole 118 formed in a manner of passing through the insulation film 107 and the insulation film 108 is placed over an overcoat layer (organic protective film) 112. Furthermore, as shown in FIG. 2A, planarly in the region of one pixel, the common electrode 103 extracted from the common wire 120 through the through hole 118 is formed in the manner of facing the pixel electrode 105.

The liquid crystal display device 100 is configured so as to place the pixel electrode 105 under the insulation film 108 placed further under the organic protective film 112 and place the common electrode 103 over the organic protective film 112. Further, it is configured so as to form one pixel in a region interposed by plural pixel electrodes 105 and common electrodes 103. Furthermore, an orientation (alignment) control film 109 is formed over the surface of the active matrix substrate formed by aligning unit pixels configured as stated above in a matrix shape, namely over the organic protective film 112 where the common electrodes 103 are formed.

Meanwhile, as shown in FIG. 1, a color filter layer 111 is placed over a glass substrate 102 constituting a color filter substrate in the manner of being partitioned by a light shielding film (black matrix) 113 into pixels and the color filter layer 111 and the light shielding film 113 are covered with an organic protective film 112 comprising a transparent insulation material. Further, the color filter substrate is configured by forming an orientation control film 109 also over the organic protective film 112.

To the orientation control film 109, a liquid crystal orientation capability is granted by using a high-pressure mercury lamp as a light source and applying linearly-polarized light irradiation of ultraviolet light extracted by using a pile polarizer formed by laminating quartz plates.

The glass substrate 101 and the glass substrate 102 are placed so as to face each other over the surfaces of the orientation control films 109 and a liquid crystal layer (liquid crystal composition layer) 110′ comprising liquid crystal molecules 110 is placed between them. Further, polarizing plates 114 are formed over the outside surfaces of the glass substrate 101 and the glass substrate 102, respectively.

In this way, an active matrix type liquid crystal display device (TFT liquid crystal display device) using a thin film transistor (TFT) is configured. In a TFT liquid crystal display device, liquid crystal molecules 110 constituting a liquid crystal composition layer 110′, when an electric field is not applied, are in the state of being oriented nearly parallel to the surfaces of the glass substrates 101 and 102 placed in the manner of facing each other and are oriented homogeneously in the state of being oriented to an initial orientation direction stipulated at photo-orientation treatment.

Here, when a voltage is applied to a gate electrode 104 and a TFT 115 is turned on, an electric field 117 is applied to a liquid crystal composition layer 110′ by an electrical potential difference between a pixel electrode 105 and a common electrode 103 and the direction of liquid crystal molecules 110 constituting the liquid crystal composition layer 110′ is changed to an electric field direction by the interaction between the dielectric anisotropy of the liquid crystal composition layer 110′ and the electric field. On this occasion, display can be carried out by changing the light transmission rate of the liquid crystal display device by the refraction anisotropy of the liquid crystal composition layer 110′ and the action of a polarizing plate 114.

Further, as an organic protective film 112, a thermosetting resin excellent in insulation performance and transparency may be used. Furthermore, a photo-curable transparent resin or an inorganic material may be used as the organic protective film 112. Moreover, an organic protective film 112 may be used also as an orientation control film 109.

In the present example, a liquid crystal display device is manufactured by forming an orientation film (orientation control film) by heating and imidizing a polyamide acid comprising the materials shown in Table 1 and changing an irradiated light quantity. That is, the materials of a polyamide acid in the present example are a first diamine represented by any one of the chemical formulae (A-1) to (A-13), a second diamine represented by the chemical formula (B-4), and an acid anhydride represented by any one of the chemical formulae (C-1) to (C-8). Further, the residual image characteristic of a liquid crystal display device according to the present example is measured and evaluated by using an oscilloscope formed by combining photodiodes. Firstly, a window pattern is displayed on a screen at a maximum brightness for 120 hours, successively the whole screen is switched to halftone display where a residual image is most distinguished, so that the brightness may be 10% of the maximum brightness in this case, and the time period until the pattern at the edge part in the window pattern disappears is evaluated as a residual image disappearance time. A residual image disappearance time allowed here is not more than 5 minutes. The results are shown in Table 1.

Good residual image characteristics are obtained in the cases of the orientation film 1-2, the orientation film 1-3, and the orientation film 1-4, namely when the second diamine is 20 mol % to 35 mol % (y=20 to 35). The diamine represented by the chemical formula (B-4) (n=5) is used as the second diamine and hence a good residual image characteristic is obtained when the relational expression 100≦n×y≦175 is satisfied. The irradiated light quantities on those occasions are 2.5 to 5.0 J/cm² and the sensitivity is also good.

Note that, the evaluation is carried out by 2-hour display in Patent Literature 1, 10-hour display in Patent Literature 2, and 50-hour display in Patent Literature 3. In the present example, the evaluation is carried out by 120-hour display and the residual image characteristic improves.

TABLE 1

| | | | | Irradiated | Residual |
|---|---|---|---|---|---|
| Orienta- | | | Acid | light | image |
| tion | Diamine | | anhydride | quantity | disappearance |
| film | (mol %) | | (mol %) | (J/cm²) | time (min.) |
| 1-1 | A(100) | — | C(100) | 1.0 | 31 |
| | | | | 2.5 | 15 |
| | | | | 5.0 | 9 |
| 1-2 | A(80) | B-4(20) | C(100) | 1.0 | 7 |
| | | | | 2.5 | 2 |
| | | | | 5.0 | 3 |
| 1-3 | A(70) | B-4(30) | C(100) | 1.0 | 10 |
| | | | | 2.5 | 4 |
| | | | | 5.0 | 3 |
| 1-4 | A(65) | B-4(35) | C(100) | 1.0 | 11 |
| | | | | 2.5 | 5 |
| | | | | 5.0 | 4 |
| 1-5 | A(60) | B-4(40) | C(100) | 1.0 | 22 |
| | | | | 2.5 | 9 |
| | | | | 5.0 | 7 |
| 1-6 | A(50) | B-4(50) | C(100) | 1.0 | 38 |
| | | | | 2.5 | 16 |
| | | | | 5.0 | 13 |
| 1-7 | — | B-4(100) | C(100) | 1.0 | 70 |
| | | | | 2.5 | 30 |
| | | | | 5.0 | 25 |

### Example 2

In the present example, a liquid crystal display device is manufactured by forming an orientation film by heating and imidizing a polyamide acid methyl ester comprising the materials shown in Table 2 and changing an irradiated light quantity. That is, the materials of a polyamide acid methyl ester in the present example are a first diamine represented by any one of the chemical formulae (A-1) to (A-13), a second diamine represented by the chemical formula (B-2), and an acid anhydride represented by any one of the chemical formulae (C-1) to (C-8). The liquid crystal display devices according to the present example are the same as the liquid crystal display devices according to Example 1 except the orientation films. Further, the residual image characteristic of a liquid crystal display device according to the present example is evaluated in the same manner as Example 1. The results are shown in Table 2.

Good residual image characteristics are obtained in the cases of the orientation film 2-2, the orientation film 2-3, the orientation film 2-4, the orientation film 2-5, and the orientation film 2-6, namely when the second diamine is 5 mol % to 90 mol % (y=5 to 90). The diamine represented by the chemical formula (B-2) (n=2) is used as the second diamine and hence a good residual image characteristic is obtained when the relational expression 10≦n×y≦180 is satisfied. The irradiated light quantities on those occasions are 2.5 to 5.0 J/cm² and the sensitivity is also good.

TABLE 2

| | | | | Irradiated | Residual |
|---|---|---|---|---|---|
| Orienta- | | | Acid | light | image |
| tion | Diamine | | anhydride | quantity | disappearance |
| film | (mol %) | | (mol %) | (J/cm²) | time (min.) |
| 2-1 | A(100) | — | C(100) | 1.0 | 21 |
| | | | | 2.5 | 12 |
| | | | | 5.0 | 7 |
| 2-2 | A(95) | B-2(5) | C(100) | 1.0 | 18 |
| | | | | 2.5 | 9 |
| | | | | 5.0 | 5 |
| 2-3 | A(90) | B-2(10) | C(100) | 1.0 | 14 |
| | | | | 2.5 | 7 |
| | | | | 5.0 | 4 |
| 2-4 | A(75) | B-2(25) | C(100) | 1.0 | 11 |
| | | | | 2.5 | 2 |
| | | | | 5.0 | 3 |
| 2-5 | A(50) | B-2(50) | C(100) | 1.0 | 13 |
| | | | | 2.5 | 3 |
| | | | | 5.0 | 3 |
| 2-6 | A(10) | B-2(90) | C(100) | 1.0 | 15 |
| | | | | 2.5 | 5 |
| | | | | 5.0 | 6 |
| 2-7 | — | B-2(100) | C(100) | 1.0 | 30 |
| | | | | 2.5 | 18 |
| | | | | 5.0 | 19 |

### Example 3

In the present example, a liquid crystal display device is manufactured by forming an orientation film by heating and imidizing a polyamide acid methyl ester comprising the materials shown in Table 3 and changing an irradiated light quantity. That is, the materials of a polyamide acid methyl ester in the present example are a first diamine represented by any one of the chemical formulae (A-1) to (A-13), a second diamine represented by the chemical formula (B-8), and an acid anhydride represented by any one of the chemical formulae (C-1) to (C-8). The liquid crystal display devices according to the present example are the same as the liquid crystal display devices according to Example 1 except the orientation films. Further, the residual image characteristic of a liquid crystal display device according to the present example is evaluated in the same manner as Example 1. The results are shown in Table 3.

Good residual image characteristics are obtained in the cases of the orientation film 3-1, the orientation film 3-2, the orientation film 3-3, and the orientation film 3-4, namely when the second diamine is 5 mol % to 25 mol % (y=5 to 25). The diamine represented by the chemical formula (B-8) (n=7) is used as the second diamine and hence a good residual image characteristic is obtained when the relational expression 3.5≦n×y≦175 is satisfied. The irradiated light quantities on those occasions are 2.5 to 5.0 J/cm² and the sensitivity is also good.

TABLE 3

| | | | | Irradiated | Residual |
|---|---|---|---|---|---|
| Orienta- | | | Acid | light | image |
| tion | Diamine | | anhydride | quantity | disappearance |
| film | (mol %) | | (mol %) | (J/cm²) | time (min.) |
| 3-1 | A(95) | B-8(5) | C(100) | 1.0 | 11 |
| | | | | 2.5 | 1 |
| | | | | 5.0 | 2 |
| 3-2 | A(90) | B-8(10) | C(100) | 1.0 | 13 |
| | | | | 2.5 | 2 |
| | | | | 5.0 | 4 |
| 3-3 | A(80) | B-8(20) | C(100) | 1.0 | 16 |
| | | | | 2.5 | 3 |
| | | | | 5.0 | 4 |
| 3-4 | A(75) | B-8(25) | C(100) | 1.0 | 18 |
| | | | | 2.5 | 5 |
| | | | | 5.0 | 7 |

### Example 4

In the present example, a liquid crystal display device is manufactured by forming an orientation film by heating and imidizing a polyamide acid ethyl ester comprising the materials shown in Table 4 and changing an irradiated light quantity. That is, the materials of a polyamide acid ethyl ester in the present example are a first diamine represented by any one of the chemical formulae (A-1) to (A-13), two kinds of second diamines represented by the chemical formulae (B-9) and (B-10), and an acid anhydride represented by any one of the chemical formulae (C-1) to (C-8). The liquid crystal display devices according to the present example are the same as the liquid crystal display devices according to Example 1 except the orientation films. Further, the residual image characteristic of a liquid crystal display device according to the present example is evaluated in the same manner as Example 1. The results are shown in Table 4.

Good residual image characteristics are obtained in the cases of the orientation film 4-2 and the orientation film 4-3, namely when the two kinds of the second diamines are 5 mol % to 10 mol % respectively (y1=5 to 10 and y2=5 to 10). The diamines represented by the chemical formulae (B-9) (n1=9) and (B-10) (n2=5) are used as the second diamines and hence a good residual image characteristic is obtained when the relational expression 65≦n1×y1+n2×y2≦140 is satisfied. The irradiated light quantities on those occasions are 2.5 to 5.0 J/cm² and the sensitivity is also good.

TABLE 4

| | | | | | Irradiated | Residual |
|---|---|---|---|---|---|---|
| Orienta- | | | | Acid | light | image |
| tion | Diamine | | | anhydride | quantity | disappearance |
| film | (mol %) | | | (mol %) | (J/cm²) | time (min.) |
| 4-1 | A(100) | — | — | C(100) | 1.0 | 24 |
| | | | | | 2.5 | 17 |
| | | | | | 5.0 | 12 |
| 4-2 | A(90) | B-9(5) | B-10(5) | C(100) | 1.0 | 16 |
| | | | | | 2.5 | 3 |
| | | | | | 5.0 | 4 |
| 4-3 | A(80) | B-9(10) | B-10(10) | C(100) | 1.0 | 18 |
| | | | | | 2.5 | 5 |
| | | | | | 5.0 | 4 |

### Example 5

In the present example, a liquid crystal display device is manufactured by forming an orientation film by heating and imidizing a polyamide acid methyl ester comprising the materials shown in Table 5 and changing an irradiated light quantity. That is, the materials of a polyamide acid methyl ester in the present example are a first diamine represented by any one of the chemical formulae (A-1) to (A-13), a second diamine represented by the chemical formula (B′-4), and an acid anhydride represented by any one of the chemical formulae (C-1) to (C-8). The liquid crystal display devices according to the present example are the same as the liquid crystal display devices according to Example 1 except the orientation films. Further, the residual image characteristic of a liquid crystal display device according to the present example is evaluated in the same manner as Example 1. The results are shown in Table 5.

Good residual image characteristics are obtained in the cases of the orientation film 5-2, the orientation film 5-3, the orientation film 5-4, the orientation film 5-5, the orientation film 5-6, and the orientation film 5-7, namely when the second diamine is 40 mol % to 90 mol % (y=40 to 90). The diamine represented by the chemical formula (B′-4) (n=1) is used as the second diamine and hence a good residual image characteristic is obtained when the relational expression 40≦n×y≦90 is satisfied. The irradiated light quantities on those occasions are 2.5 to 5.0 J/cm² and the sensitivity is also good.

TABLE 5

| | | | | Irradiated | Residual |
|---|---|---|---|---|---|
| Orienta- | | | Acid | light | image |
| tion | Diamine | | anhydride | quantity | disappearance |
| film | (mol %) | | (mol %) | (J/cm²) | time (min.) |
| 5-1 | A(70) | B′-4(30) | C(100) | 1.0 | 20 |
| | | | | 2.5 | 10 |
| | | | | 5.0 | 9 |
| 5-2 | A(60) | B′-4(40) | C(100) | 1.0 | 16 |
| | | | | 2.5 | 8 |
| | | | | 5.0 | 5 |
| 5-3 | A(50) | B′-4(50) | C(100) | 1.0 | 12 |
| | | | | 2.5 | 6 |
| | | | | 5.0 | 4 |
| 5-4 | A(40) | B′-4(60) | C(100) | 1.0 | 10 |
| | | | | 2.5 | 4 |
| | | | | 5.0 | 4 |
| 5-5 | A(30) | B′-4(70) | C(100) | 1.0 | 8 |
| | | | | 2.5 | 2 |
| | | | | 5.0 | 3 |
| 5-6 | A(20) | B′-4(80) | C(100) | 1.0 | 9 |
| | | | | 2.5 | 3 |
| | | | | 5.0 | 3 |
| 5-7 | A(10) | B′-4(90) | C(100) | 1.0 | 15 |
| | | | | 2.5 | 5 |
| | | | | 5.0 | 7 |
| 5-8 | — | B′-4(100) | C(100) | 1.0 | 22 |
| | | | | 2.5 | 9 |
| | | | | 5.0 | 10 |

Although the invention established by the present inventors has heretofore been explained concretely on the basis of the embodiments and the examples, it goes without saying that the present invention is not limited to the embodiments and the examples and can be modified variously.

What is claimed is:

1. A liquid crystal display device comprising substrates, a liquid crystal layer, an electrode group to apply an electric field to said liquid crystal layer, and orientation control films placed between said substrates and said liquid crystal layer, wherein:
each of said orientation control films comprises a polyimide and a polyimide precursor;
as the materials of said polyimide and said polyimide precursor, at least one kind of diamines selected from the chemical compound group shown by the following chemical formula (1), at least one kind of diamines selected from the chemical compound group shown by the following chemical formula (2), and a cyclobutane tetracarboxylic dianhydride derivative are contained; and
an orientation restraining force is granted by the irradiation of nearly linearly polarized light.
H₂N-A¹-NH₂ (1)
Here, A¹ represents a divalent circular substituent.
H₂N-A²Zₙ-A²-NH₂ (2)
Here, A² individually represents a divalent circular substituent or a single bond, Z individually represents a bond group selected from the group of —(CH₂)—, —(NH)—, —O—, —S—, —SiO₂—, and —CO—, and n represents an integer of 1 or more.

2. A liquid crystal display device according to claim 1, wherein the relational expression 0<n×y<200 is satisfied when at least one kind of diamines selected from said chemical compound group shown by said chemical formula (2) is contained by y (mol %) and n is an integer of 2 or more.

3. A liquid crystal display device according to claim 2, wherein the relational expression 10≦n×y≦175 is satisfied.

4. A liquid crystal display device according to claim 2, wherein the relational expression 20≦n×y≦150 is satisfied.

5. A liquid crystal display device according to claim 1, wherein the relational expression 0<(n₁×y₁)+(n₂×y₂)<200 is satisfied when two kinds of diamines selected from said chemical compound group shown by said chemical formula (2) are contained, n of a diamine is defined as n₁ and said diamine is contained by y₁ (mol %), n of the other diamine is defined as n₂ and said other diamine is contained by y₂ (mol %), and each of n₁ and n₂ is an integer of 2 or more.

6. A liquid crystal display device according to claim 5, wherein the relational expression 10≦(n₁×y₁)+(n₂×y₂)≦175 is satisfied.

7. A liquid crystal display device according to claim 5, wherein the relational expression 20≦(n₁×y₁)+(n₂×y₂)≦150 is satisfied.

8. A liquid crystal display device according to claim 1, wherein said cyclobutane tetracarboxylic dianhydride derivative has a structure represented by the following chemical formula (3). 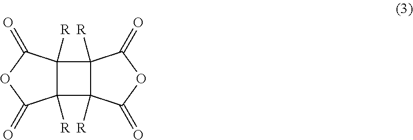
Here, R individually represents an alkyl group having a carbon number of 1 to 8.

9. A liquid crystal display device according to claim 1, wherein said polyimide precursor is a polyamide acid alkyl ester having a carbon number of 1 to 8.

10. A liquid crystal display device according to claim 9, wherein said polyimide precursor contains a polyamide acid.

11. A liquid crystal display device according to claim 1, wherein said A¹ and A² contain one kind selected from the divalent circular chemical compound group shown by the following chemical formulae (4) to (11). 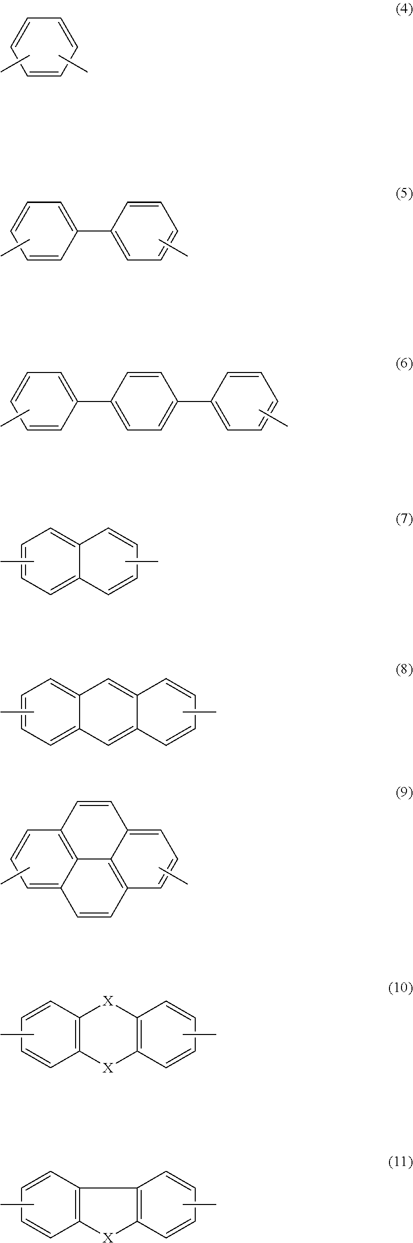
Here, X individually represents a bond group selected from the group of —(CH₂)—, —(NH)—, —O—, —S—, and —CO—.

12. A liquid crystal display device according to claim 1, wherein the relational expression 40<y<100 is satisfied when at least one kind of diamines selected from said chemical compound group shown by said chemical formula (2) is contained by y (mol %) and n is 1.

13. A liquid crystal display device according to claim 12, wherein the relational expression 50≦y≦90 is satisfied.

14. A liquid crystal display device according to claim 12, wherein the relational expression 60≦y≦80 is satisfied.
